(19) United States
(12) Patent Application Publication
(10) Pub. No.: US 2007/0138269 A1
(43) Pub. Date: Jun. 21, 2007

(54) Self-service checkout system

(75) Inventors: Gunter Baitz, Berlin (DE); Michael Blecke, Berlin (DE)

Correspondence Address: HARNESS, DICKEY & PIERCE, P.L.C., P.O. BOX 828, BLOOMFIELD HILLS, MI, 48303, US

(73) Assignee: Wincor Nixdorf International GmbH

(21) Appl. No.: 11/606,205

(22) Filed: Nov. 29, 2006

(30) Foreign Application Priority Data
Dec. 21, 2005 (DE) 102005061734.4

(51) Int. Cl. G06K 15/00

(52) U.S. Cl. 235/383

(57) ABSTRACT

Self-service checkout system having a merchandise-registration device 5 with a scanner 8 for registering the merchandise, a screen 14 for displaying merchandise data, a payment device with at least one coin-depositing and coin-dispensing device and a data-processing device, with the merchandise-registration device 5 comprising a base segment 6 and a head segment 7 which can be pivoted about a vertical axis of rotation V and can be pivoted through 180° with respect to the base segment 6, with the head segment 7 comprising at least the scanner 8 for registering the merchandise, the screen 14 for displaying merchandise data, and the payment device with at least one coin-depositing and coin-dispensing device.

The invention relates to a self-service checkout system having a merchandise-registration device with an integrated payment device.

U.S. Pat. No. 6,363,355 B1 discloses a self-service checkout system which enables the customers of a supermarket to themselves register the merchandise and articles they intended to purchase and preferably carry out the payment operation themselves. The self-service checkout system has a first setting-down device for merchandise, on which device the merchandise can be set down and from which device said merchandise can then be supplied to an adjacent merchandise-registration device. The merchandise-registration device has a scanner for registering the barcode. A second setting-down device for merchandise, which device comprises bag holders for securing shopping bags, adjoins the merchandise-registration device. The bag holder is preferably formed in such a way that the shopping bags are in an open position, so that the registered merchandise can immediately be placed in the shopping bag. Weighing scales are integrated in the second setting-down device, so that the weight of the merchandise placed in the shopping bags can be determined and plausibility calculations can be carried out in order to prevent cheating during the subsequent payment process which is carried out on a payment device.

However, these self-service checkout systems can only be operated from the front. However, this is very impractical when the self-service checkout system is intended to be used by employees of the supermarket as a checkout, as is particularly the case during peak times. Since a customer generally requires more time to register his merchandise than trained checkout personnel and only a limited number of checkouts are available in a supermarket, it is expedient to temporarily change over operation of the checkout system from self-service to service by qualified personnel.

The object of the present invention is therefore to develop a self-service checkout system in such a way that it can also be used for attended merchandise registration.

In order to achieve this object, the invention in conjunction with the preamble of patent claim 1 is characterized in that the merchandise-registration device of the self-service checkout system comprises a base segment and a head segment which can be pivoted about a vertical axis of rotation with respect to the base segment, with the head segment comprising at least a scanner for registering the merchandise, a screen for customer information and a payment device.

The particular advantage of the invention is that operation of the self-service system from the rear is possible by rotating the head segment of the checkout system. As a result, service personnel can be positioned at the self-service checkout system, as in customary checkout systems, on the opposite side to the customer. The checkout system according to the invention therefore allows flexible use of the checkout system without long conversion times, it being possible for the operator of the checkout system to decide whether said checkout system is used for self-service by the customer or for service by qualified personnel.

According to one preferred embodiment of the invention, a second setting-down device for the registered merchandise has a pivotable bag holder, so that the head segment of the merchandise-registration device can be pivoted from the self-service position to the service position about a vertical axis in an unobstructed manner.

Further advantages of the invention can be found in the further subclaims.

One exemplary embodiment of the invention is explained in greater detail below with reference to the drawings, in which:

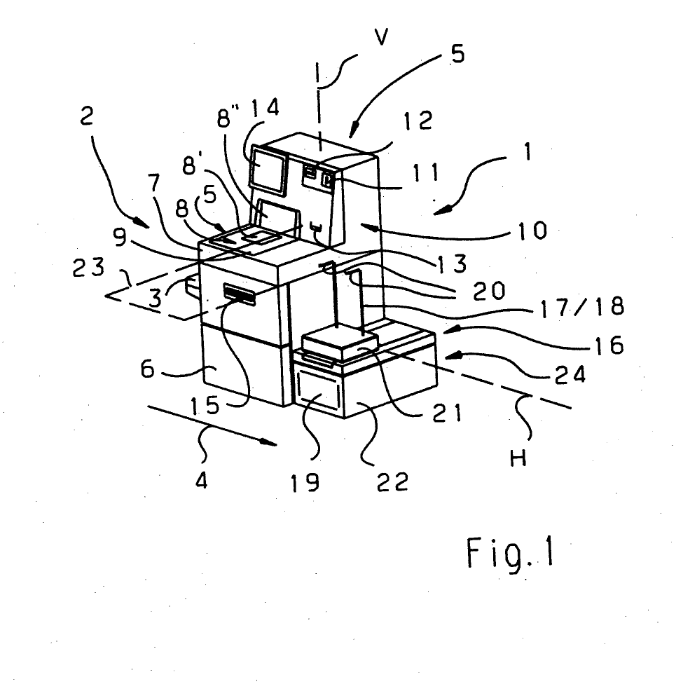

FIG. 1 shows a perspective illustration of a self-service checkout system,

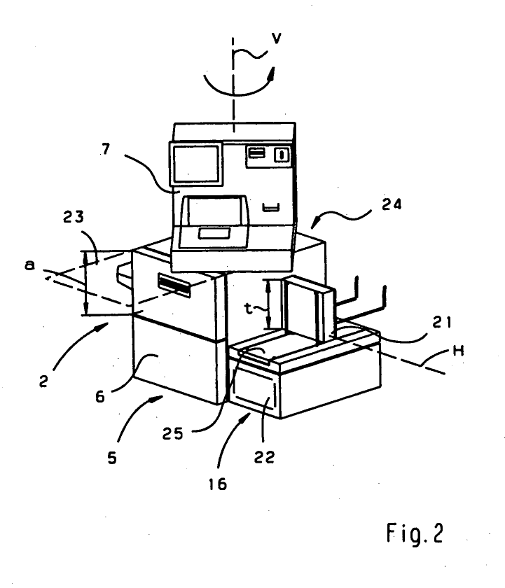

FIG. 2 shows a perspective illustration of the self-service checkout system during the pivoting movement of the head segment, and

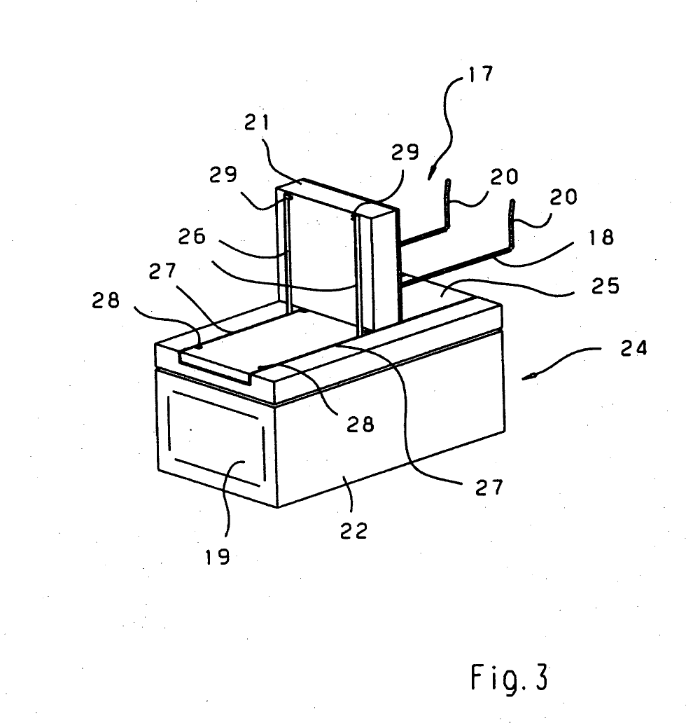

FIG. 3 shows an enlarged illustration of a second setting-down device of the self-service checkout system in a lower position of a bag holder.

At a self-service checkout system 1 according to FIG. 1, a customer of a supermarket registers the merchandise he wishes to buy and carries out the payment operation himself—without the assistance of a supermarket worker.

The self-service checkout system 1 comprises a plurality of components which are connected to one another. The self-service checkout system 1 has a first setting-down device 2 which has a horizontal support surface 3 on which a shopping basket and the merchandise contained therein can be put down at a height which is convenient for the customer. The setting-down surface 3 is preferably attached to a side wall of a merchandise-registration device 5 which directly adjoins the first setting-down device 2 in the processing direction 4. The first setting-down device 2 therefore preferably does not have its own base.

The merchandise-registration device 5 comprises a stationary base segment 6 and a head segment 7 which can be pivoted about a vertical axis V. A scanner 8 for registering coding of the merchandise, such as a barcode, and weighing scales 9 for weight detection are accommodated in the head segment 7. The scanner preferably has a horizontal scanner pane 8′ and a second, vertical scanner pane 8″. Furthermore, a payment device 10 with a coin-depositing device 11 and a banknote-depositing device 12 for depositing banknotes is integrated in the head segment 7. A card reader (not illustrated) can also be provided, so that the payment operation can be performed by means of a bank card or credit card.

The head segment 7 also has a dispensing opening 13 for coins. Furthermore, a dispensing slot for dispensing a receipt can also be provided. A screen 14 serves to display the registered merchandise and/or the price of the merchandise when the customer registers the merchandise coding by means of the scanner 8. In this way, the customer always has a good overview of the merchandise which has already been registered by means of the scanner 8. The screen 14 may also be in the form of a touchscreen, in order to allow simple operator control by the customer. The head segment 7 also has a data-processing device in which the registered merchandise data can be processed.

A banknote storage means with a winding store or a cassette for depositing and dispensing banknotes may be accommodated in the base segment 6. A dispensing compartment 15 is provided for dispensing the banknotes, so that banknotes can also be dispensed as change during the payment operation. Since the banknote storage means is usually accommodated in a vault for security reasons, the base segment is of correspondingly solid design.

A second setting-down device 16 on which the scanned-in merchandise can be set down item by item adjoins the merchandise-detection device 5 in the processing direction 4. To this end, the second setting-down device 16 has a bag holder 17 for securing shopping bags (not illustrated). The bag holder 17 comprises a frame 18 with two retaining webs 20 which are directed toward the front 19 of the second setting-down device 16. The retaining webs 20 serve to hold opposing tabs of a shopping bag, so that the shopping bag can be moved to an open position in order to receive the previously scanned-in merchandise.

The frame 18 is firmly connected to a base element 21 which is arranged on a base 22 of the setting-down device 16 such that it can be moved and locked. Weighing scales are arranged in the base element 21 or in the base 22 in order to weigh the merchandise which has been set down. In particular, the weight of the merchandise which has been placed in the shopping bags is to be checked for monitoring purposes.

In the initial position of the bag holder 17 according to FIG. 1, the retaining webs 20 extend above a base plane 23 of the pivotable head segment 7. Before the head segment 7 is rotated through 180° about the vertical axis V in order to allow merchandise to be registered from the rear 24 of the checkout system 1 by a supermarket worker, the bag holder 17 is pivoted about a horizontal axis H. As can be seen more clearly from FIGS. 2 and 3, the rear of the base element 21 of the bag holder 17 is mounted on the base 22 in a pivotable manner. Pivoting the base element 21 causes the bag holder 17 to extend substantially in the horizontal direction. Since the depth t of the base element 21 is less than the distance a between an upper face 25 of the base 22 and the base plane 23 of the head segment 7, the head segment 7 of the merchandise-registration device 5 can be rotated through 180°, with an intermediate position of the rotary movement being illustrated in FIG. 2.

As soon as the head segment 7 has been rotated through 180°, the bag holder 17 can again be moved from the lower position into the upper position. It is now possible for a supermarket worker to register merchandise at the rear 24 of the checkout system 1. The customer only needs to place the merchandise on the support surface 3 of the first setting-down device 2. The supermarket worker picks up the merchandise individually and registers said merchandise by means of the scanner 8. The worker can then set down the merchandise, for example in the shopping bag which is provided for this purpose and has already been opened by means of the bag holder 17. Since the base element 21 is mounted on the base 22 such that it can move, the bag holder 17 can be moved in the direction of the rear of the checkout system 1 and the worker can place the merchandise in the bag in a convenient manner. Information about the scanned-in merchandise can be displayed by a second screen (not illustrated) which—like the card-reading device—is fitted to the head segment 7 in an articulated manner. In the service position, payment is made in the conventional manner by the customer either handing cash to the supermarket worker or paying by means of a bank/store card. The customer is then given a receipt by the supermarket worker. The customer has therefore finished shopping.

In the self-service position, both merchandise registration and the payment operation are performed solely by the customer in the conventional manner, without the assistance of a supermarket worker.

The base has suitable guide means in order to enable the bag holder 17 to be pivoted. Furthermore, two parallel guide webs 26 are arranged on the lower face of the base element 21, which guide webs engage in corresponding rails 27 of the base 22 in the upper position of the bag holder 17. The rail 27 has a respective cutout 28 in its front and rear regions, and the latching lugs 29 at the end of the guide webs 26 engage in said cutouts 28. This allows the bag holder to be pivoted and locked. However, other technical arrangements for facilitating the ability of the bag holder to move and pivot are also feasible within the scope of the invention.

1. A self-service checkout system having a merchandise-registration device with a scanner (8) for registering the merchandise, a screen (14) for displaying merchandise data, a payment device with at least one coin-depositing and coin-dispensing device, and a data-processing device, the merchandise-registration device (5) including a base segment (6) and a head segment (7) which can be pivoted about a vertical axis of rotation (V) and can be pivoted through 180° with respect to the base segment (6), with the head segment (7) including at least the scanner (8) for registering the merchandise, the screen (14) for displaying merchandise data, and the payment device with at least one coin-depositing and coin-dispensing device.

2. The self-service checkout system as claimed in claim 1, wherein the base segment (6) is provided with a banknote storage means and a dispensing apparatus for banknotes.

3. The self-service checkout system as claimed in claim 1 further comprising a first and a second setting-down apparatus (2, 16) for setting down the merchandise before and after said merchandise is registered, with the second setting-down apparatus (16) having a bag holder (17) which is mounted on the setting-down apparatus (16) in a movable and pivotable manner.

4. The self-service checkout system as claimed in claimed 3, wherein the second setting-down device (16) has guide means such that the bag holder (17) can be pivoted out of an upper position, in which it is arranged above a base plane (23) of the head segment (7), into a lower position in which it is arranged beneath the base plane (23) of the head segment (7).

5. The self-service checkout system as claimed in claim 3 wherein, in its upper position, the bag holder (17) is arranged upright with a vertical frame (18) and with at least one retaining web (20) which projects toward the front (19) of the second setting-down device (16) in order to hold tabs of the shopping bag.

6. Apparatus for checking merchandise, said apparatus being convertible from a self-service configuration to a cashier operated configuration, said apparatus comprising:
a console having a stationary base with a front face and a rear face, an upper member rotatably mounted on the base, the upper member having a horizontal surface upon which merchandise is placed for scanning and a vertical surface containing at least one display device; the upper member being pivotable about a vertical axis from a self-service position where the display faces a customer and a front edge of the horizontal surface is generally aligned with the front face of the base, to a cashier position where the display faces an opposite direction and the front edge of the horizontal surface is generally aligned with the rear face of the base.

7. The apparatus of claim 6 which further comprises:
a bagging station adjacent a lower side of the base, said station having a stationary base and an upper section rotatably mounted about a horizontal axis on the base, the upper section having at least one stake extending therefrom to which a shopping bag can be attached; and
wherein the stake normally extends at least to the height of the horizontal surface of the upper member of the console, but is pivotable out of the way to permit rotation of the upper member from the self-service position to the cashier position.
